(19) United States
(12) Patent Application Publication
(10) Pub. No.: US 2017/0189891 A1
(43) Pub. Date: Jul. 6, 2017

(54) SYSTEM AND METHOD OF PRODUCING A CHAR SUPPORT NICKEL CATALYST FOR USE IN SYNGAS PRODUCTION

(71) Applicant: The Board of Regents for Oklahoma State University, Stillwater, OK (US)

(72) Inventors: Ajay KUMAR, Stillwater, OK (US); Kezhen QIAN, Stillwater, OK (US); Danielle D. BELLMER, Stillwater, OK (US); Guolong ZHANG, Stillwater, OK (US); Krushna N. PATIL, Stillwater, OK (US)

(21) Appl. No.: 15/313,391

(22) PCT Filed: May 28, 2015
(86) PCT No.: PCT/US15/32984

§ 371 Date: Nov. 22, 2016

Related U.S. Application Data
(60) Provisional application No. 62/003,959, filed on May 28, 2014.

(51) Int. Cl. B01J 21/18; B01J 23/70; C01B 3/40; B01J 35/10; B01J 37/02; B01J 37/16; B01J 23/38; B01J 23/755

(52) U.S. Cl. CPC B01J 21/18; B01J 23/38; B01J 23/70; B01J 23/755; B01J 35/10; B01J 37/0201; B01J 37/0203; B01J 37/0207; B01J 37/16; C01B 3/40; C01B 2203/0233; C01B 2203/1041; C01B 2203/1252

(57) ABSTRACT

According to an embodiment there is provided a method of developing catalysts that are able to reduce the levels of tars in the syngas by reforming. One embodiment develops a co-catalyst, char supported nickel catalyst, for syngas conditioning. Biomass-derived char does not only serve as a support, but also plays a role in catalyzing the reactions. Biomass-derived char is a byproduct of biomass thermo-conversion process. In one variation, hydrazine was used to reduce supported Ni² into Ni⁰. Compared with the traditional method of reducing nickel with hydrogen flow, this reduction method increases nickel dispersion rate and reduces nickel particle size.

### CROSS REFERENCE TO RELATED APPLICATIONS

This application claims the benefit of U.S. Provisional Patent Application serial number 62/003,959 filed on May 28, 2014, and incorporates said provisional application by reference into this document as if fully set out at this point.

### STATEMENT REGARDING FEDERAL SPONSORED RESEARCH OR DEVELOPMENT

This invention was made with U.S. Government support under DOT Grant No. DTOS59-07-G-00053 awarded by the Department of Transportation and under USDA/NIFA Grant No. 2010-38502-21836 awarded by the Department of Agriculture. The Government has certain rights in this invention.

### TECHNICAL FIELD

This invention generally relates to the production of syngas and, more particularly, to systems and methods of producing syngas with reduced contaminants and an improved composition.

### BACKGROUND

Char is the non-graphitizable non-fluid product of carbonization of carbonaceous precursors such as coal and biomass. Char derived from biomass is popularly known as biochar. Biochar can be synthesized from a variety of feedstocks, including perennial grasses, forestry waste, crop residues, animal manure, sewage, and waste. Being rich in carbon, biochar also can be used as a source of fuel. For high-value applications, biochar can be converted into activated carbon that can be used as an adsorbent, catalyst support, or catalyst.

Gasification converts biomass into synthesis gas (syngas), a mixture of primarily carbon monoxide, carbon dioxide and hydrogen. The produced syngas can be further used as a feedstock for hydrocarbon fuels production through the Fischer-Tropsch synthesis (FTS) process, which produces hydrocarbons of different lengths. However, biomass-generated syngas cannot generally be used directly because it contains high concentrations of tars, a mixture of several aromatic compounds that must be removed prior to utilization of syngas.

Syngas cleanup and conditioning are technical barriers to syngas becoming an economically viable fuel precursor in that it costs almost 50% of the biofuel cost through gasification. Catalytic upgrading of syngas has emerged as an effective technique for syngas cleanup and upgrading. Various metal catalysts have received attention, such as those incorporating nickel, molybdenum, cerium, iron, and rhodium. Ni-based and Mo-based catalysts are considered the most promising for tar removal due to their high catalytic reactivity. However, despite their high efficiency, these precious metal catalysts have limitations, such as high costs, the tendency for coking and deactivation, poisoning due to other contaminants in the syngas stream (e.g., NH₃ and H₂S), and the complex synthesis technique that requires high temperature and pressure. These sorts of issues have seriously limited the use of biomass gasification as a method to produce sustainable fuels.

What is needed is an improved method of producing a sustainable and environmentally friendly fuel derived from lignocellulosic biomass by developing and utilizing novel technologies for energy-related transformations. Successfully meeting this goal will increase energy security and reduce the environmental impacts caused by the use of fossil fuels.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

According to an embodiment, there are provided herein methods to use char derived from gasification for high-value applications such as syngas conditioning, refining, gas storage, etc. An embodiment teaches a chemical method of preparing activated carbon from biochar for use as support for a catalyst.

According to other embodiments, there are provided systems and methods of impregnating or loading nickel or other transition metals (including, without limitation, the platinum group metals) onto biochar to produce a catalyst for tar removal. For purposes of the instant disclosure, the terms “loading” and “impregnating” will be used interchangeably and include, without, limitation coating of all exterior surfaces, including pores if present.

In various embodiments, the catalyst might be nickel acetate on biochar, nickel nitrate on biochar with activated carbon, and nickel acetate treated with hydrazine on biochar with activated carbon. One aspect of this invention utilizes a co-catalyst, a char supported nickel catalyst, for syngas conditioning. More particularly, one aspect of this embodiment produces catalysts that are able to effectively reduce the levels of tars in syngas by reforming. In one embodiment, hydrazine was used to reduce supported Ni²⁺ into Ni⁰. Compared with the traditional method of reducing nickel with hydrogen flow, this reduction method increases nickel dispersion rate and reduces Nickel particle size.

As one example, red cedar-derived char can be used as a support material for nickel. In this example, the red cedar char was collected from downdraft bed gasification and was chemically activated into activate carbon. A first type of catalyst was prepared by mild oxidation of activated carbon (support) with nitric acid and reduction of impregnated nickel acetate or nickel nitrate with hydrogen; another type of catalyst was prepared by reduction of nickel acetate with hydrazine. The properties of char based catalysts have been evaluated using TEM, XRD and N₂ isotherms, and the catalysts' performances were tested in steam reforming of toluene (a model tar compound).

According to another embodiment, nickel nitrate proved, in this case, to be a better nickel precursor than nickel acetate for preparation of char supported nickel catalyst. However, both are well suited for use in connection with the present disclosure.

The catalyst impregnated with nickel nitrate was found more active in steam reforming of toluene than catalyst impregnated with nickel acetate. The TEM results indicated that the nickel particle size of catalyst impregnated with nickel nitrate was much smaller than that of catalyst impregnated with nickel acetate. The particle size of catalyst impregnated with nickel acetate was decreased by hydrazine reduction but was still larger than catalyst impregnated with nickel nitrate. The primary gas product of steam reforming of toluene was H₂ followed by CO and CO₂. The H₂ content and CO₂ decreased as the temperature increased from 600 to 700° C. while the CO content increased with decrease in temperature.

According to still another embodiment, a char-derived catalyst (nickel acetate treated with hydrazine on biochar with activated carbon) was tested for removal of tar produced from pyrolysis of kraft lignin in a pyroprobe reactor. The effects of reaction temperature (700, 800 and 900° C.), water amount (5-10 μl), pressure (0.1-2.2 MPa) and atmosphere (inert and hydrogen) on catalytic conditioning of tar components were assessed. Catechols were the most abundant tar components followed by phenols and guaiacols during non-catalytic kraft lignin pyrolysis. Results indicated that the char-based catalyst effectively decreased the contents of lignin tar. Reaction temperature, water loading and reaction pressure significantly affected the tar removal. An increase in reaction temperature led to an increase in removal efficiency of most tar components except naphthalene. Excessive water loading (10 μl) decreased the tar removal efficiency of the char-based catalyst. High pressure promoted the catalytic conditioning of lignin tar. Tar contents decreased significantly when hydrogen was used as a gasification agent and thus promoted the conversion of lignin into non-condensable gas.

According to another embodiment there is provided an activated carbon support catalyst, comprising activated carbon derived from biochar impregnated with a transition metal.

According to a further embodiment, there is provided a method of chemically preparing activated carbon from biochar, the method comprising the steps of: mixing biochar with a chemical activation agent selected from the group consisting of ZnCl₂, KOH, H₃PO₄, NaOH, and K₂CO₃; drying said mixture; heating said mixture for a predetermined period of time to effect carbonization and activation without substantial carbon loss; substantially removing said chemical activation agent from said mixture to produce an activated carbon.

According to another embodiment, there is provided a method of producing an activated carbon support catalyst, the method comprising the steps of: obtaining activated carbon derived from biochar; impregnating said actuated carbon with a transition metal to obtain an activated carbon support catalyst.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIG. 1 contains an illustration of an exemplary XRD pattern of activated carbon supports and nickel catalysts for an embodiment.

FIGS. 2A-2C contain gas composition in product gas of toluene steam reforming as a function of temperature (dry and nitrogen free basis) for an embodiment.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

Herein is taught a method of developing activated carbon-supported Ni-catalysts that hold great promise because of the synergy between the functions of Ni and activated carbon. The high reactivity of Ni-based catalysts is effective for heavy tar cracking, and the biochar-based support is effective for light tar cracking and removal of NH₃ and H₂S. In addition, the increased surface area of the activated carbon support should increase resistance to deactivation and thus improve the catalyst's lifespan.

### Embodiments

An embodiment taught herein uses Ni or other transition metal as an active metal with activated carbon such as derived from biochar as the support (as compared to only activated carbon as the catalyst or adsorbent).

According to this embodiment, the two main steps for the preparation of activated carbon are: (i) carbonization of the raw material (such as agriculture residue) under an inert atmosphere or poor oxygen atmosphere to produce char and (ii) activation of the char. The activation method could be either physical or chemical.

Physical activation activates char at a suitable temperature in the presence of suitable oxidizing gases such as CO₂, steam, and air.

An embodiment utilizes chemical activation that can involve either one or two steps. In the one-step chemical activation process, the carbonization and activation steps are carried out simultaneously using the activating chemical agent. Two-step chemical activation involves carbonization of the raw material followed by activation of the carbonization product by mixing the product with a chemical agent. Chemical activation agents might be ZnCl₂, KOH, H₃PO₄, NaOH, and K₂CO₃. The advantage of one-step chemical activation is that it less time-consuming. Compared with one-step chemical activation and physical activation, two-step chemical activation produces highly microporous activated carbon with high surface area. If carbon is used as a catalyst support, the activity is mainly determined by the chemical composition of the active site and the dispersion of the active sites. Studies of iron catalyst activity created via Fisher-Tropsch (FT) synthesis suggest that microporosity of the support influences iron dispersion. Catalysts with high iron dispersion can be produced using activated carbons with a high internal surface area and a high proportion of micropores. In this embodiment, chemical activation with KOH will be used to produce char-derived activated carbon to facilitate high Ni dispersion on the support. Some embodiments use NaOH at this step.

According to this embodiment, char for making catalysts was produced from gasification of eastern red cedar in a downdraft gasifier. Of course, any source of biomass could have been used instead. The gasification temperature was around 900° C. Ni(NO₃)₂.6H₂O, Ni(CH₃COO)₂.4H₂O (≧99.0%) and hydrazine anhydrate (50-60%).

Pre-treatment of the char could include treatment with various types of acids (e.g., H₂SO₄, HNO₃) and treatment with various reducing agents, such as hydrazine or NaBH₄. Acid treatment can increase surface oxygenated groups on the activated carbon, and thus increase its catalytic activity. By way of summary, HNO₃ treatments can lead to an increase in oxygen bearing groups on the exterior and interior surfaces of the activated carbon, but also enhanced dispersion of Pt. The catalyst activity test showed that the treated catalyst exhibited higher efficiency as compared to the untreated catalyst. Treating the catalyst with reducing agent produces nanoparticle metal catalyst with small average particle size (e.g., about 5 to 50 nm) and high dispersive ratio. The hydrazine reduction process improved metal dispersion and catalyst efficiency. With respect to metal dispersion, that term should be understood to be the percentage, quantity, etc., of metal ions that are exposed and available to catalyze reactions as determined by, for example, TEM (transmission electron microscopy) imaging.

In more particular and continuing with the present example, one catalyst was prepared by mild oxidation of activated carbon (support) with nitric acid and reduction of impregnated nickel acetate or nickel nitrate with hydrogen. A second type of catalyst was prepared by reduction of nickel acetate with hydrazine. The catalysts' performances were tested in steam reforming of toluene (a model tar compound).

In this embodiment, biochar was mixed with KOH and soaked for 2 h. The mixture was dried in an oven overnight at 105° C. The dried mixture was then placed in a fixed-bed tubular reactor and activated. The reactor was first heated to 300° C. and held at this temperature for 2 h to prevent carbon loss from biochar. For carbonization, the temperature was then raised to 800° C. and biochar was activated at this temperature for 1.5 h under nitrogen flow of 200 ml/min to create an inert environment. In some embodiments the flow rate might be between about 50 and 1000 ml/min. After carbonization, the biochar was washed with deionized water until the pH of leaching water reached 7.

Continuing with this example, the activated carbon was treated with 30% HNO₃ (or other acid known to a person of ordinary skill in the art) before loading nickel. In some embodiments, the percentage of HNO₃ might be between 5% and 40%. However, the treatment with acid is optional and, if performed, can act to increase the efficacy of the catalyst end product. The activated carbon was loaded into a flask and immersed in a water bath at 70° C. After 1.5 h acid treatment, activated carbon was filtered from the suspension into a funnel and washed with deionized water until pH of the filtered solution reached neutral. The acid soaked biochar was then dried in an oven at 105° C. overnight.

The dried acid treated activated carbon was wet impregnated in a solution of nickel acetate or nickel nitrate. Note that, although the text that follows discusses the use of nickel as a specific example, it is contemplated that other transition could be used instead including, without limitation, copper, zinc, iron, cobalt, gold, palladium, platinum and the platinum group metals.

The concentration of the nickel acetate solution was calculated before impregnation in order to achieve 10 wt. % nickel loading. In some embodiment, the nickel loading might be as high as 20 wt. % or higher (0<wt %≦20), but 9% to 10% would be a typical loading goal. The mixture was ultrasonicated for 3 h and kept in a vacuum desiccator for 16 h. The soaked samples were then dried in the oven at 105° C. and denoted as Ni-AC—N (activated carbon loaded with nickel nitrate) and Ni-AC-A (activated carbon loaded with nickel acetate).

To evaluate the effect of hydrazine reduction on catalyst properties, Ni-AC-A was further treated with hydrazine. Of course, another reducing agent could be used instead including, for example, NaBH₄, and those of ordinary skill in the art would be readily able to choose same.

The catalyst precursor was soaked in a 2.0 M hydrazine (e.g., up to about 0.1 M hydrazine per gram of biochar, 0 <M hydrazine≦0.1) solution for reduction. The reduction of nickel catalyst precursor was performed in a 250 ml three necked flask that was immersed in a hot water bath. The reaction flask was fitted with a reflux condenser, a thermometer and gas tubing for using helium to purge the air out of the flask. The mixture of nickel catalyst precursor and hydrazine solution was stirred at 80° C. for 4 h. After reduction, the catalyst was filtered and the excess hydrazine left in catalyst was washed off with deionized water. The catalyst was then dried in an oven at 105° C. before test and denoted as Ni-AC-AH.

Specific surface areas (S_{BET}) and pore volumes of the catalyst were measured using a liquid nitrogen isothermal method and listed below in Table 1. Based on these results, char surface area was significantly increased by chemical activation (increased from 60 m²/g to 1570 m²/g). Acid treatment did not significantly reduce the surface area of activated carbon. 10% nickel loading significantly decreased the surface area of activated carbon (reduced about 30-40%). The red cedar char was dominated by mesopores (52 vol. %), followed by micropores (42 vol. %) with total pore volume of 0.04 cm³/g. After activation, the total pore volume of activated carbon increased and so did the volume percent of micropores. More detailed pore size information was obtained from pore distribution analysis. Large quantities of micropores (<2 nm) and mesopores (2-50 nm) were detected. The mesopores were mostly composed of small mesopores (<8 nm).

TABLE 1
Texture properties of the different activate carbons and Ni catalyst.

| | | | | | | Total pore | D_{Ni}, | D_{Ni}, |
|---|---|---|---|---|---|---|---|---|
| | S_{BET}, | V_{micro}, | V_{micro}, | Vₘₑₛₒ, | Vₘₑₛₒ, | volume | TEM | XRD |
| | (m²/g) | (cm³/g) | (%) | (cm³/g) | (%) | (cm³/g) | (nm) | (nm) |
| Raw char | 68 | 0.02 | 42.85 | 0.02 | 52.38 | 0.04 | NA | N.A. |
| AC | 1570 | 0.50 | 62.50 | 0.30 | 37.50 | 0.80 | NA | N.A. |
| Acid AC | 1524 | 0.50 | 70.40 | 0.21 | 29.60 | 0.71 | NA | N.A. |
| Ni-AC-N | 965 | 0.31 | 73.80 | 0.11 | 26.20 | 0.42 | 7-13 | N.A. |
| Ni-AC-A | 945 | 0.30 | 75.00 | 0.10 | 25.00 | 0.40 | 15-39 | 18 |
| Ni-AC-AH | 1021 | 0.35 | 79.50 | 0.06 | 20.50 | 0.44 | 11-18 | 17 |

“NA” means not applicable

Compared with acid activated carbon, the volume percent of micropores of Ni-AC—N and Ni-AC-A increased while volume percent of mesopores of Ni-AC—N and Ni-AC-A decreased. Peak corresponding to mesopores with pore diameter 8-10 nm presented in activated carbon supports but disappeared on Ni-AC—N and Ni-AC-A. The decrease of mesopores could possibly be due to integration of nickel to mesopores.

Oxygenated functional groups on activated carbon were analyzed using TPD and FT-IR. Volatiles desorption occurred at different temperatures due to decomposition of various oxygenated functional groups over activated carbon surface. The decomposition temperatures of different oxygen bearing surfaces with TPD are well studied in literatures: the low temperature peak resulted from decomposition of carboxylic acids (200-300° C.); the medium temperature peaks were assigned to lactones (190-650° C.); higher temperature decompositions were associated with carboxylic anhydrides, carbonyl, phenols, ethers, carbonyls and quinone groups (700-1000° C.). Peaks were observed in all temperature regions for both activated carbon and acid treated activated carbon, indicating that activated carbon and acid treated activated carbon contained multiple oxygen functional groups. The peaks of acid treated activated carbon were higher than peaks of raw activated carbon, indicating that acid treatment increased the quantity of surface oxygen functional groups on activated carbon.

Small bands observed on region 1140-1000 cm⁻¹, 1620-1450 cm⁻¹ and 1700 cm⁻¹ FTIR spectra were assigned to ether, quinone and lactonic groups. Those three bands on the spectrum of acid treated activated carbon were more intense than activated carbon, suggesting that the acid treated activated carbon contained larger amounts of ether, quinone and lactonic groups than activated carbon. The observation of greater quinone groups was consistent with results from TPD.

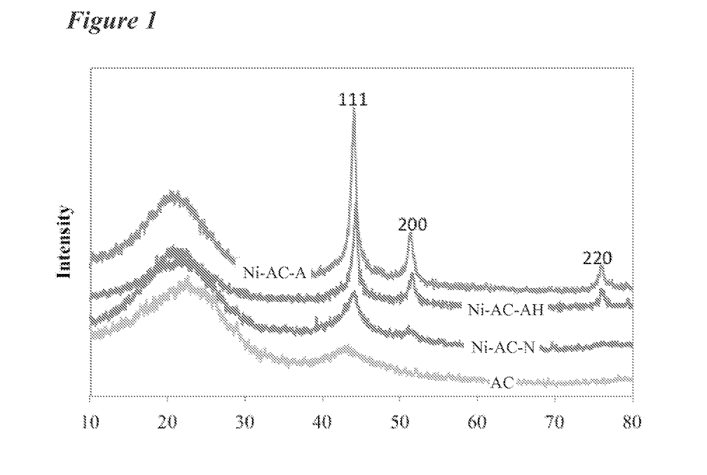

With respect to XRD analysis (FIG. 1), one broad peak at 23° and one weak peak at around 43° were observed on activated carbon. The peak at 23° was attributed to the (002) reflection of the graphitic-type lattice and the peak at 43° corresponded to a superposition of (100) and (101) reflections of the graphitic-type lattice. The broadness and weakness of two reflection peaks of activated carbon indicated a low degree of graphitization. The XRD patterns of the Ni-AC-A and Ni-AC-AH showed three reflection peaks at 44.5° and 51.5° and 76.4°. Those peaks were assigned to crystal planes of 111, 200 and 220 of metallic nickel with a face-centered cubic structure. The signals on spectrum of Ni-AC-AH were less intense than Ni-AC-A, suggesting a smaller nickel particle size and better metal dispersion on Ni-AC-AH. XRD pattern of Ni-AC—N only showed two peaks at 44.5° and 51.5°. Both peaks were less intense than XRD peaks of Ni-AC-AH and Ni-AC-A, suggesting that Ni-AC—N had the highest nickel dispersion and smallest nickel particle size. The nickel crystal sizes of Ni-AC-A and Ni-AC-AH were estimated using the Scherrer equation by knowing line broadening at half the maximum intensity of the most intense peak. The estimation of nickel crystal size of Ni-AC—N was not possible to difficulty in obtaining the line broadening at half the maximum intensity of the most intense peak.

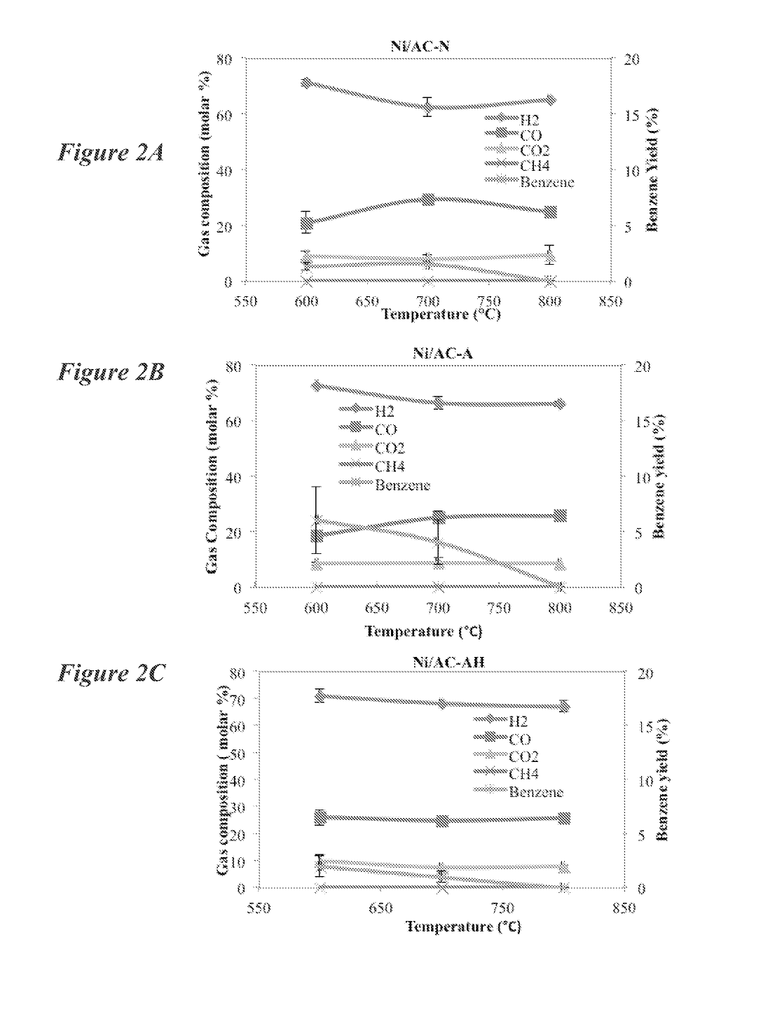

As shown in FIGS. 2A-2C, low benzene yield was observed at all conditions (0-2%), except for Ni-AC-A catalyst at 600 and 700° C. (4-9%). For all catalysts, benzene yield decreased as the reaction temperature increased from 600 to 800° C. The decrease in benzene yield was probably because high temperature promoted the decomposition of benzene into permanent gases. Benzene is more thermally stable than toluene and its decomposition requires more energy.

In summary with respect to the current embodiment, nickel nitrate was found to be a good nickel precursor for preparing char supported nickel catalyst. The catalytic efficiency of toluene removal for the three catalysts was ranked from highest to lowest as Ni-AC—N >Ni-AC-AH>Ni-AC-A. Nickel particle size of the catalyst impregnated with nickel nitrate (Ni-AC—N) was smaller than that of catalyst impregnated with nickel acetate (Ni-AC-A and Ni-AC-AH). The particle size of catalyst impregnated with nickel acetate decreased with hydrazine reduction but was still larger than catalyst impregnated with nickel nitrate. The primary gas product of steam reforming of toluene was H₂ followed by CO and CO₂, The H₂ content and CO₂ decreased as the temperature increased from 600 to 700° C. while the CO content increased with decrease in temperature.

With respect to toluene and naphthalene steam reforming, in this embodiment when temperature was below 900° C., the conversions of toluene and naphthalene were similar.

At 900° C., the conversion of toluene was significantly higher than that of naphthalene. Increase in temperature significantly increased reforming efficiencies of both toluene and naphthalene: the toluene conversion increased from 36% to 99% and naphthalene conversion increased from 37% to 92% as temperature increased from 700 to 900° C. The conversion of toluene alone (without naphthalene) was significantly higher than that of naphthalene/toluene. The conversion of toluene alone was 87% at 700° C., while conversion was only 36% for naphthalene/toluene reforming. This indicated that steam reforming of toluene in naphthalene/toluene was more difficult than steam reforming of toluene alone. The decrease of benzene removal efficiency in the presence of naphthalene might be explained as follows: the adsorption of naphthalene on the surface of the catalyst occurred strongly, thereby decreasing the conversion of benzene. Benzene adsorbed only weakly and thus did not influence the catalytic conversion. At temperature below 900° C., naphthalene did not completely reform and the unconverted naphthalene strongly adsorbed on the surface of the catalyst. As a result, adsorbed naphthalene might have covered the active sites on catalyst and affected the reforming efficiency. According to still another embodiment, a char-derived catalyst was tested for removal of tar produced from pyrolysis of kraft lignin in a pyroprobe reactor. The effects of reaction temperature (700, 800 and 900° C.), water amount (5-10 μl), pressure (0.1-2.2 MPa) and atmosphere (inert and hydrogen) on catalytic conditioning of tar components were assessed. In this embodiment, catechols were the most abundant tar components followed by phenols and guaiacols during non-catalytic kraft lignin pyrolysis. Results indicated that the char-based catalyst effectively decreased the contents of lignin tar. Reaction temperature, water loading and reaction pressure significantly affected the tar removal. An increase in reaction temperature led to an increase in removal efficiency of most tar components except naphthalene. At the lowest pyroprobe temperature (700° C.), the average removal of phenolics was about 50%. Catechols were removed more than 85%, which was the highest among all individual phenolics. However, almost no aromatic hydrocarbons were removed at 700° C. When the pyroprobe temperature was raised to 900° C., more than 90% of phenolics and 60% of monoaromatic hydrocarbons were removed while removal percentages of naphthalene. 1,5-dimethylnaphthalene and 2-methylnaphthalene were still less than 30%. The removal efficiencies of the char-derived catalysts on individual tar compounds can be attributed to reactivity and stability of each compound. Excessive water loading (10 μl) decreased the tar removal efficiency of the char-based catalyst. High pressure also promoted the catalytic conditioning of lignin tar. When pressure increased from 0.1 to 1.1 MPa (0 to 150 psig), the removal percentage of most aromatic hydrocarbons increased from nearly 0% to 70% and the removal percentage of phenols increased from 30% to 70%. Catechol, 2-methoxyvinylphenol, 4-methylcatechol and o-xylene at 1.1 MPa (150 psig) reached nearly 100% removal. Tar contents decreased significantly when hydrogen was used as a gasification agent and thus promoted the conversion of lignin into non-condensable gas.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)—(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An activated carbon support catalyst, comprising:
activated carbon derived from biochar impregnated with a transition metal.

2. The method of claim 1 wherein said transition metal is selected from a group consisting of nickel, molybdenum, copper, zinc, iron, cobalt, gold, palladium, platinum, and the platinum group metals.

3. The method of claim 2 wherein said transition metal is nickel.

4. The method of claim 3 wherein said nickel is a nickel precursor selected from the group consisting of nickel acetate, reduced nickel acetate, and nickel nitrate.

5. A method of chemically preparing activated carbon from biochar, the method comprising:
mixing biochar with a chemical activation agent selected from the group consisting of ZnCl₂, KOH, H₃PO₄, NaOH, and K₂CO₃;
drying said mixture;
heating said mixture for a predetermined period of time to effect carbonization and activation without substantial carbon loss;
substantially removing said chemical activation agent from said mixture to produce an activated carbon.

6. The method of claim 5 wherein said mixture is maintained in an inert environment during at least a portion of said predetermined period of time.

7. The method of claim 5 further including heating said mixture at a first temperature for a period of time and at a second temperature for a period of time.

8. The method of claim 7 wherein said first temperature is approximately 300° C. and said mixture is heated for approximately 2 hours.

9. The mixture of claim 7 wherein said second temperature is approximately 800° C. and said mixture is heated for approximately 1.5 hours in an inert environment.

10. The method of claim 9 wherein said low-oxygen environment is created by flowing nitrogen through said mixture.

11. The method of claim 10 wherein said nitrogen flow is between approximately 50 ml/min and 1000 ml/min.

12. The method of claim 5 wherein said chemical activation agent is substantially removed by washing said mixture with deionized water.

13. The method of claim 5 wherein said activated carbon is subjected to syngas.

14. The method of claim 5 wherein said activated carbon is loaded with a transition metal catalyst to produce a char support transition metal catalyst.

15. The method of claim 14 wherein said char support transition metal catalyst is subjected to syngas.

16. A method of producing an activated carbon support catalyst, the method comprising:
obtaining activated carbon derived from biochar;
impregnating said activated carbon with a transition metal to obtain an activated carbon support catalyst.

17. The method of claim 16 wherein said transition metal is selected from the group consisting of nickel, molybdenum, copper, zinc, cerium, iron, gold, platinum, and the platinum group metals.

18. The method of claim 16 wherein said transition metal is nickel in a solution selected from the group consisting of nickel acetate and nickel nitrate to form a nickel impregnated activated carbon support catalyst.

19. The method of claim 18 wherein said nickel impregnated activated carbon support catalyst is Ni-AC-A and said method further comprising reducing said Ni-AC-A to Ni-AC-AH.

20. The method of claim 19 wherein said Ni-AC-A is reduced by being subjected to a reducing agent selected from the group consisting of NaBH₄ and hydrazine.

21. The method of claim 20 wherein said reducing agent is hydrazine.

22. The method of claim 21 further comprising:
soaking said Ni-AC-A in a 2.0 M hydrazine solution while stirring at approximately 80° C. for approximately 4 hours to reduce said Ni-Ac-A;
filtering, washing, and drying said reduced Ni-AC-A to form Ni-AC-AH.
